(19) United States
(12) Patent Application Publication
(10) Pub. No.: US 2020/0374149 A1
(43) Pub. Date: Nov. 26, 2020

(54) SYSTEMS AND METHODS FOR THE IMPLEMENTATION OF AN AI/IOT HUB IN THE CONTROL OF ELECTRICAL DEVICES, ELECTRONICS AND APPLIANCES

(71) Applicant: L & A Electronic, Corp, Miami, FL (US)

(72) Inventors: Luis Alberto Bernal Barros, Miami, FL (US); Oscar Javier Alvarez, Miami, FL (US)

(73) Assignee: L & A Electronic, Corp, Miami, FL (US)

(21) Appl. No.: 16/419,981

(22) Filed: May 22, 2019

(51) Int. Cl. H04L 12/28; H04L 29/08; G06N 20/00; H04W 76/10; H04W 4/80

(52) U.S. Cl. CPC H04L 12/2816; H04L 12/2829; H04L 12/2807; H04L 2012/2841; G06N 20/00; H04W 76/10; H04W 4/80; H04L 67/125

(57) ABSTRACT

An Artificial Intelligence/Internet of Things (AI/IOT) HUB with at least one Internet connection interface, for forming an Internet connection and access to various services including IoT services and for controlling a plurality of controlled devices includes at least one user interface and one or processors for creating a local communication channel among HUBs, simultaneously configuring HUBs with minimal user intervention, controlling the controlled devices using infrared (IR), radio frequency (RF), Wifi, or Bluetooth signals, and controlling several of the controlled devices simultaneously for a conditioning of a room or a zone. In some embodiments, the HUB can detect current conditions within the zone or the room having the controlled devices after activating the controlled devices and provide feedback confirming the conditioning of the room or of the zone.

### CROSS-REFERENCE TO RELATED PATENT APPLICATIONS

Not Applicable.

### BACKGROUND

### Field

This disclosure is related to the field of automation systems, more specifically, the disclosure relates to methods and systems for platforms that can be implemented in the automation of the Internet of Things (IoT).

### Description of the Related Art

With the passage of time, more and more Artificial Intelligence/Internet of Things (AI/IoT) devices come to the market offering users greater comfort and ease of use. It is expected that the number of devices will continue to grow as technology continues its exponential growth to a point where we can have completely interconnected cities with the buildings, inhabitants and devices building intelligent arrangements that facilitate the life of the users. However, most of these devices are very expensive for the average user, causing its distribution to be very slow, adding that each brand has different lines or products that are incompatible with others. There is a noticeable lack of a system capable of unifying already existing IoT services and enable old electronic devices or household appliances to be controlled remotely with the efficiency and ease of their new counterparts.

### BRIEF DESCRIPTION OF THE DRAWINGS

For a better understanding of the disclosure, some illustrations and detailed descriptions have been provided, from which clearer information can be obtained, these are:

FIG. 1A shows several implementations in accordance with the embodiments making use of different connections and services.

FIG. 1B illustrates the different configurations that can be made with multiple zones, IOT HUBs and devices in accordance with the embodiments.

FIG. 2 is a block diagram of an internal architecture of an AI/IOT HUB in accordance with the embodiments.

FIG. 3 is a block diagram of internal logic to change the connection of one Wifi network to another in accordance with the embodiments.

FIGS. 4A-B illustrate several flow charts including alternative solutions for connectivity when losing a main connection to the Internet in accordance with the embodiments.

FIG. 5 is a diagram illustrating a possible flow for a configuration of an AI/IOT HUB in accordance with the embodiments.

FIG. 6 illustrates a flow chart of a configuration process for devices controlled by radiofrequency signals in accordance with the embodiments.

FIG. 7 illustrates a flow chart of a configuration process for devices controlled by infrared signals in accordance with the embodiments.

FIG. 8 illustrates a flow chart including the steps to follow for a configuration of a scene (control by macro-commands) in accordance with the embodiments.

FIG. 9 illustrates a flow chart of a process for feedback of a state of the devices in a zone in accordance with the embodiments.

FIGS. 10A, 10B, and 10C illustrate different ways in which an AI/IOT HUB can be implemented in accordance with the embodiments.

FIGS. 11A-B illustrate a flow chart of a massive AI/IOT HUB configuration process in accordance with the embodiments.

### DETAILED DESCRIPTION

In the following description, numerous specific details are given to provide a better understanding of the different application forms of the embodiments.

In this way it will be visible to someone who possesses sufficient knowledge in the area that the applications of the embodiments can be applied, omitting some of the specific details. On the other hand, some of the aforementioned elements, which are widely known by the general public, are represented in a simplified manner to avoid diverting the focus of attention, from the embodiments described herein.

One of the embodiments is an Internet of Things (IoT) device, which can be used by developers to integrate other Internet of Things (IoT) devices, allowing them to increase the ways and options by which these can manipulate the devices. Some of the embodiments herein present a system that unifies services of current IoT devices and enables other household appliances or electronic devices of the home or office to be controlled remotely, as well as the possibility of giving the user information regarding its current status. Further, the more IoT devices reach the home or office, new methods are needed to facilitate the configuration of these new devices which currently requires the tedious steps of configuration again and again with each of them.

Another embodiment can include an Internet of Things (IoT) device capable of emitting various types of non-visible spectrum signals (radio frequency, infrared, bluetooth, WiFi, as examples), which can be used to control remotely or locally, other Electronic devices at the user's disposal that have one or more of the above reception means intended for control.

In addition to those mentioned above, an application of the embodiments described herein includes the possibility of capturing a static image or a number of static images by means of an image sensor, which can be used by a user to determine and/or verify the status of the electronic devices or desired environment in the room or zone and within the visual range of the optics (such as 206°) corresponding to the image sensor.

Another application of the embodiments includes two preferred control methods by which the user will be able to interact with the device, without ruling out the possibility of including new methods by making use of the different types of connectivity and signals that the device possesses. This preferential control will be through an application designed for Android or iOS Smartphone (or other smart devices such as tablets and with other operating systems as applicable), and additionally through a WEBSOCKET, which will allow a broader control in terms of the number of devices to be controlled simultaneously.

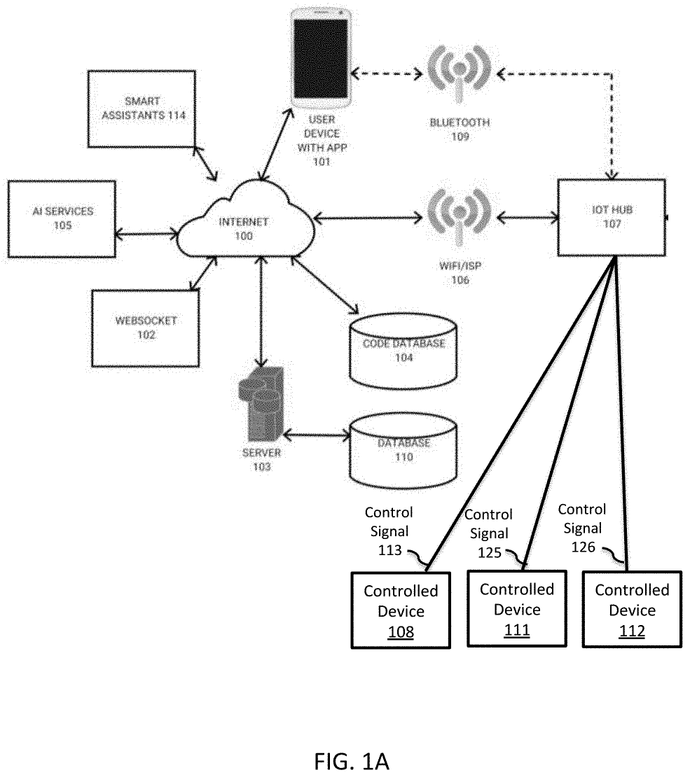

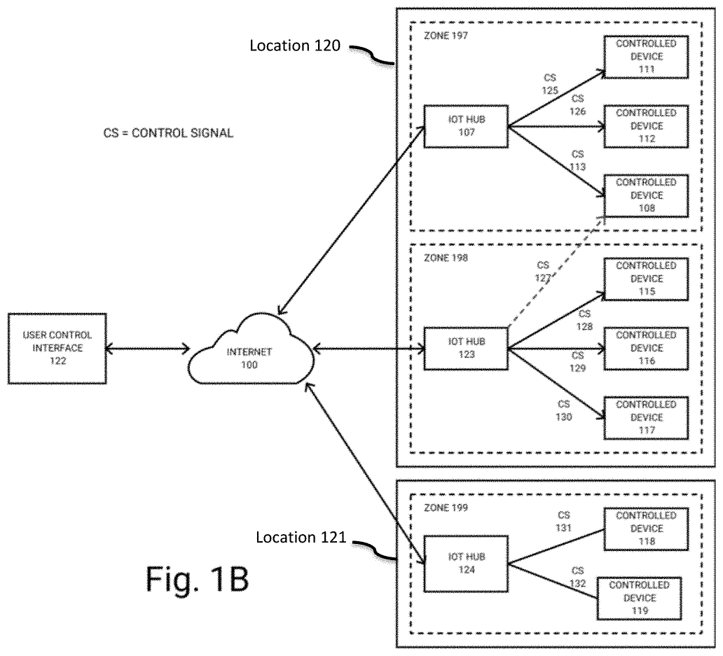

FIG. 1A shows an overview of the architecture on which the embodiments or applications of the embodiments will be implemented, in particular some CONTROLLED DEVICES 108, 111, and 112 are represented, without this being a limitation to the total number of devices that can be integrated, all being controlled by an IOT HUB 107 through CONTROL SIGNALS 113, 125, and 126 which can be of different types, depending on the CONTROLLED DEVICE 108, 111, and 112. In one example, the CONTROLLED DEVICES can represent a television set, a light fixture or fixtures, and remote controlled curtains. Of course, any number of other controlled devices can be included and the embodiments are not necessarily limited by the number or type of devices deployed.

The IOT HUB 107 has different types of network connections via BLUETOOTH 109 or via WIFI/ISP 106 which will be used as the communication channel, depending on the availability of one or the other. Through the WIFI/ISP 106, the IOT HUB 107 has a duplex communication (reception and transmission) with the control platform of the user's choice, which can be a WEBSOCKET 102 implemented in a WEB page or a USER DEVICE WITH APP 101 which in some embodiments can be represented by a smartphone, a tablet, or laptop with an appropriate application. Without limiting only to these two control platforms using a connection to the INTERNET 100, such platforms serve as a bridge between the different services offered, including AI SERVICES 105, which offer artificial intelligence functions, or additional services that provide greater flexibility and functionality to the user, and access to a CODE DATABASE 104, which provides a large amount of encrypted codes that will be used to control the various CONTROLLED DEVICES 108, 111, and 112. The artificial intelligence functions can utilize any number of techniques including neural networks, machine learning, natural language processing, or statistical learning as well as algorithms or mathematical tools such as hidden Markov models, information theory, or normative Bayesian decision theory.

Further, access to SERVER 103 in addition to processing relevant information for proper operation, in turn gives access to DATABASE 110.

The connection method using BLUETOOTH 109, is an alternative to control the IOT HUB 107, which can be used locally, in case, for some reason, connectivity to the INTERNET 100 is lost through the WIFI/ISP connection 106.

On the other hand, the AI/IOT HUB 107 can have various sensors, such as humidity, temperature, or image sensors, among others, which will serve to provide information or feedback to the user about the state of the room where the AI/IOT HUB 107 resides, and in the same way generates updates in the DATABASE 110 that enables generating reports of use, alerts, notifications, or other diverse uses in conjunction with the AI SERVICES 105.

Despite the capacity of the AI/IOT HUB 107 to provide feedback through various sensors, some of the CONTROLLED DEVICES 108, 111, and 112 may have the possibility of delivering reports of its current status by themselves, including information that is delivered to the USER DEVICE WITH APP 101 or WEBSOCKET 102 for the same purpose of informing the user and/or updating DATABASE 110.

All the IOT HUB(s) 107 or CONTROLLED DEVICES 108, 111, or 112 should be previously configured properly according to the instructions that can be shown in the USER DEVICE WITH APP 101 or WEBSOCKET 102. After configuration, it is possible to add a new method of control through INTELLIGENT ASSISTANTS 114 making use of the AI SERVICES 105 enabling the user to send commands using his/her voice, or through different means serving as an interface as the INTELLIGENT ASSISTANTS 114 may assist in configuring.

In FIG. 1B, several additional connection possibilities are shown for a set of IOT HUBs 107,123, or 124. In this embodiment, a single user can have several AI/IOT HUBs 107-123 configured in the same LOCATION 120 (for example, the user's home). A multiple HUB configuration increases control in different ZONES 197 and 198 and facilitates handling more CONTROLLED DEVICES 108, 111, 112, 115, 116, and 117 within LOCATION 120. In some embodiments, the ZONES can represent different rooms within a home or different areas of communication coverage within a home or office which can encompass single or multiple rooms in some embodiments.

It should be clarified that the only limitation regarding the number of CONTROLLED DEVICES 108, 111, 112, 115, 116, and 117 for each AI/IOT HUB 107-123 in each ZONE 197-198 lies in the scope of the CONTROL SIGNALS 113, 125, 126, 127, 128, 129 and 130 in accordance with its type (infrared, radio-frequency, bluetooth, or Wifi) will have different penetration and/or range properties. Apart from these properties, there can be an unlimited number of devices in each zone.

Because of some of the properties noted above, another embodiment can utilize the AI/IOT HUB 123 in ZONE 198 to control the CONTROLLED DEVICE 108 which resides in the ZONE 197 by means of the CONTROL SIGNAL 127. CONTROL SIGNAL 127 can be the equivalent to the CONTROL SIGNAL 113 issued by the AI/IOT HUB 107, wherein both signals must have the appropriate line of sight, distance, penetration, protocol and/or power needed to reach the CONTROLLED DEVICE 108.

Of course, in order to do this previously, the configuration process for the CONTROLLED DEVICE 108 must be performed through the USER CONTROL INTERFACE 122 (WebSocket or Mobile Application installed on the user's device) as previously referenced with respect FIG. 1A, in each of the AI/IOT HUBs 107-123 that will control this device.

On the other hand, another application of the embodiments shown in FIG. 1B, due to its capability to connect to INTERNET 100, the user can have multiple AI/IOT HUBs 107, 123, and/or 124 configured in different ZONES 197, 198, and/or 199 and at the same time in different LOCATIONS 120-121 each connected to a common Wi-Fi network, or to different networks, for example, AI/IOT HUBs 107-123 in certain ZONES 197-198 in a LOCATION 120 that can be in a home, and AI/IOT HUB 124 in another ZONE 199 found in a different LOCATION 121 that can be an office, where you have the CONTROLLED DEVICES 118-119 being manipulated with CONTROL SIGNALS 131-132.

Each one of the AI/IOT HUBs 107-123-124 and CONTROLLED DEVICES 108-111-112-115-116-117-118-119 should be previously configured through the USER CONTROL INTERFACE 122, which will automatically associate each of them, to a ZONE 197-198-199 specified within the user's account, which will be updated both in the USER CONTROL INTERFACE 122, and in the services and databases of the architecture referenced with respect to FIG. 1A. Note, there is no limit as to the amount of AI/IOT HUBs 107-123-124 or CONTROLLED DEVICES 108-111-112-115-116-117-118-119 that can be added.

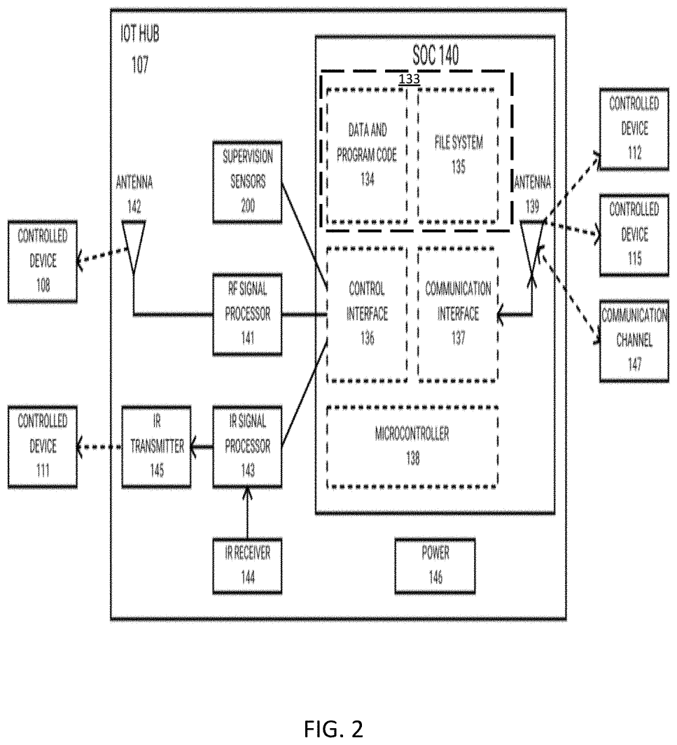

As illustrated in FIG. 2, an application of the AI/IOT HUB 107 can contain an equal or similar architecture, with many internal components that together enable to offer all the functionality explained above.

The most important part of all this construction is included in the SOC 140 which is itself a system composed of various components, responsible for controlling everything that happens. For this purpose, the DATA AND PROGRAM CODE 134 will exist in the INTERNAL MEMORY 133, which will give the control logic and execute the microcontroller or MCU 138, as well as the commands as received from the COMMUNICATION CHANNEL 147 (Wifi or bluetooth depending on the state connection) through the ANTENNA 139 and processed in the COMMUNICATION INTERFACE 137.

In the same way, there is also a FILE SYSTEM 135 in the INTERNAL MEMORY 133 that can be used to store information such as control codes, credentials to create connections with Wi-Fi networks or via Bluetooth, configuration files, updates downloads for the firmware, or images, and other information without being limited to these. Which, if required and as established in the PROGRAM DATA AND CODE 134, can be used by the other components of AI/IOT HUB 107 as SUPERVISION SENSORS 200, SIGNAL PROCESSOR 141 and IR SIGNAL PROCESSOR 143.

Despite having a large number of components and areas integrated in the SOC 140, the principles of the embodiments are not limited to this particular implementation, and thus INTERNAL MEMORY 133, COMMUNICATION INTERFACE 137, MCU 138, and ANTENNA 139, among other components may be distributed among different components of the system and be connected through a specific communication protocol.

The particular application of the embodiments shown in FIG. 2, demonstrates how the AI/IOT HUB 107 can be connected and simultaneously control various CONTROLLED DEVICES 108-111-112-115 through various components, according to the type of signal used to communicate and/or receive orders. For the embodiment shown in FIG. 2, the CONTROLLED DEVICE 108 is being controlled by means of radio frequency signals coming from the ANTENNA 142, which will emit a wave modulated by the RF SIGNAL PROCESSOR 141, after receiving the appropriate command by the user from the COMMUNICATION CHANNEL 147 and processed by the MCU 138 according to the logic established in the DATA AND PROGRAM CODE 134.

In the same way, the CONTROLLED DEVICE 111 is handled by means of an infrared signal, generated in the IR SIGNAL PROCESSOR 143 and transmitted through the IR TRANSMITTER 145. The IR RECEIVER 144 can be used to receive infrared signals that pass through the IR 143 SIGNAL PROCESSOR; these can be from the original remote control of the CONTROLLED DEVICE 111, for reasons of learning the IR code, or, from the same CONTROLLED DEVICE 111 in response to the control signal sent, if the CONTROLLED DEVICE 111 has such capability.

The CONTROLLED DEVICES 112-115 are controlled by signals coming from the same ANTENNA 139; however, depending on the type of device, the signal generated by the COMMUNICATION INTERFACE 137 will be able to use the Bluetooth or Wifi protocol. This embodiment is described herein without limiting the connectivity with the COMMUNICATION CHANNEL 147 that uses the same means to make the connection with the user's control system.

In the application described in FIG. 2, it shows how the AI/IOT HUB 107 has a POWER SUPPLY 146, which can come from various sources such as a power adapter, powered by a plug in the home, or a base that has a rechargeable battery. However, the type of power source can vary without this affecting in any way the operation or the principles of the embodiments, and should not be limited to the disclosed embodiments and could easily include for example a wireless power system.

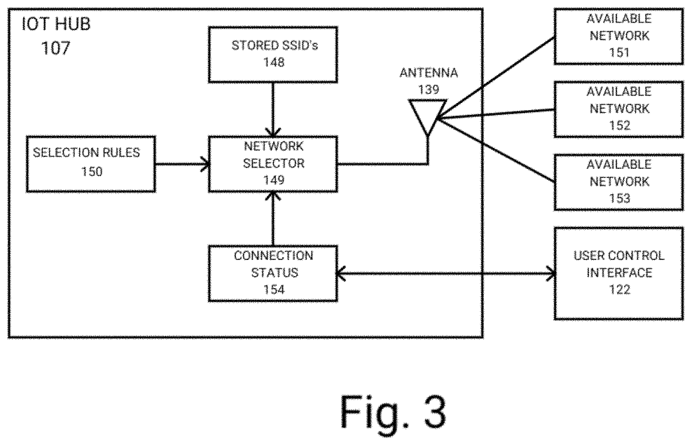

FIG. 3 shows how the AI/IOT HUB 107 has an internal logic for selecting between 2 or more available WIFI (or other) NETWORKS 151-152-153.

This selection process only takes place if the CONNECTION STATUS 154 detects that there is a lot of instability or connectivity failure with the USER CONTROL INTERFACE 122 (which can be a device with the app installed, or a browser accessing the WebSocket).

From this moment (of detecting instability or connectivity failure), the AI/IOT HUB 107 initiates an internal task to recover a good communication link with the USER CONTROL INTERFACE 122. For this internal task, the ANTENNA 139 initially scans the available WIFI NETWORKS 151-152-153 for evaluation by the NETWORK SELECTOR 149.

The first filtering is a comparison made taking into account the matches of available WIFI NETWORKS 151-152-153 with STORED CREDENTIALS 148, thus avoiding the evaluation process with networks incapable of connecting.

Subsequently, the connection with one of these specific WIFI NETWORKS 151-152-153, depends on the factors programmed within the SELECTION RULES 150, which are entered into the NETWORK SELECTOR 149 as the parameters considered during the selection process.

For this process to be carried out, multiple access points have previously been configured and thus generate in the internal memory of the IOT HUB 107 the file with the STORED CREDENTIALS 148 (e.g., SSIDs), through the USER CONTROL INTERFACE 122.

Several rules can be implemented in the architecture resulting in different scopes and coverage for the device IOT HUB 107. Among the most common, is filtering according to signal strength level (RSSI), however, this filtering does not guarantee the connection by the NETWORK SELECTOR 149. Therefore, the CONNECTION STATUS 154 performs a validation when the connectivity of the IOT HUB 107 is recovered and when connecting to one of the WIFI NETWORKS 151-152-153 to verify that there is good communication with the USER CONTROL INTERFACE 122.

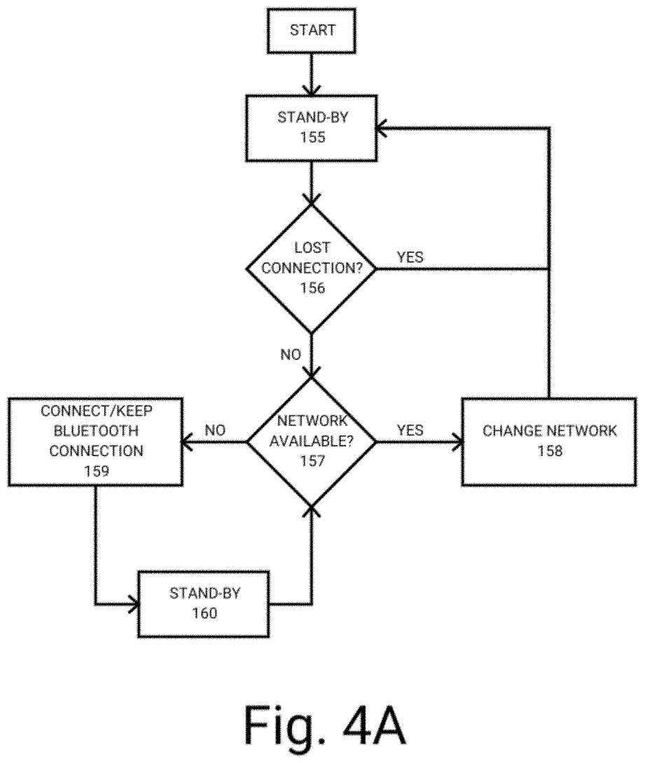

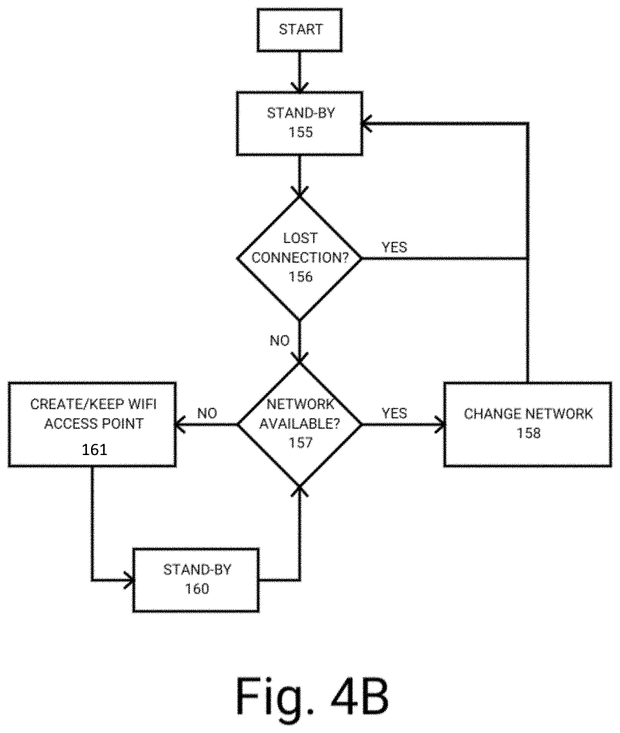

The embodiments are designed for use mainly with an Internet connection; however, an alternative communication system and network can be used in case you lose the connection to the Internet as shown in the flow diagram of FIG. 4A.

After having started its normal operation, the embodiment of FIG. 4A is able to remain in STAND BY mode at block 155, where it will wait for any instruction sent by the user. While it remains in this state, a KEEP-ALIVE signal is sent, which, if delivered, guarantees that there is still a connection to the Internet at decision block 156.

In case there is no communication, the system will check if there are other AVAILABLE NETWORKS at decision block 157. If there is an available network that meets the criteria as discussed above with reference to FIG. 3, then the system will generate a CHANGE NETWORK instruction at block 158, which will reestablish communication.

If there are no other AVAILABLE NETWORKS at decision block 157, then the system will proceed to start an (OFFLINE) BLUETOOTH CONNECTION mode at block 159, in which it will be placed waiting for a connection via Bluetooth, or will maintain a Bluetooth connection as the case may be, and will move to a new state of STAND-BY at block 160, and wait for packages via Bluetooth services sent by the paired device. If it is possible to obtain an AVAILABLE NETWORK at decision block 157, then the system proceeds to perform a NETWORK CHANGE at block 158 and returns to the initial state of STAND-BY at block 155.

Similar to FIG. 4A, in FIG. 4B, another possibility is presented in the implementation of an alternate communication (absence of Internet connection) for the embodiments.

After searching and not finding any AVAILABLE NETWORKS at decision block 157, an OFFLINE ACCESS POINT MODE at block 161 is started, which in this embodiments creates a Wi-Fi hotspot that has an internal server dedicated to receiving commands, by means of requests using HTTP protocol.

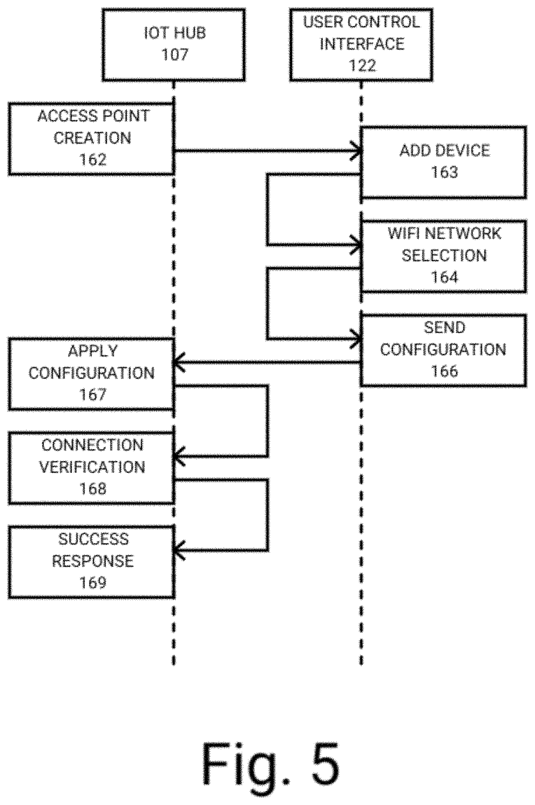

The embodiments have several methods for configuring an AI/IOT HUB 107 depending on the number of devices to be connected; the first of them, for the connection of individual devices is shown in FIG. 5.

If the AI/IOT HUB 107 has already been previously configured and the user wants to reconfigure from scratch, it must be factory reset to reach the starting point shown in FIG. 5. On the other hand, if the AI/IOT HUB 107 is new, it should only be power fed.

The process of configuring an AI/IOT HUB 107 requires interaction by the user to execute certain tasks and input some essential data. On the IOT HUB 107 side the process starts with the CREATION of an ACCESS POINT (AP) at block 162, which will generate a Wi-Fi network enabling any device working in the 2.4 GHz band to connect where the communication channel is between the AI/IOT HUB 107 and the USER CONTROL INTERFACE 122. This channel creating happens as soon as the AI/IOT HUB 107 is connected to a power supply as long as it is factory set.

Once you are in this initial state, the AI/IOT HUB 107 can guide or indicate the user through a physical medium (via sight or sound) so that the process can begin from the user's side.

The user must make use of the USER CONTROL INTERFACE 122 to start the process executing the command ADD DEVICE at block 163 either on a mobile device with an application or through a browser using a WebSocket for example.

When initiating the process, the user will be guided with different screens that will be shown in the USER CONTROL INTERFACE 122.

Initially, the user must do the WIFI NETWORK SELECTION at block 164 to indicate which of the AI/IOT HUBs 107 should be connected, which can be done in different ways: selecting from a list of available Wi-Fi networks, which is obtained when performing an SSID scan from the USER CONTROL INTERFACE 122; or manually entering credentials, name of the network (SSID) and password (in case of a protected network) in text fields.

Subsequently, the USER CONTROL INTERFACE 122 will perform a search for devices in which it will search for Wifi access nodes/points that have a specific name (name generated by AI/IOT HUB 107 during CREATION of an AP at block 162) until finding the AI/IOT HUB 107 desired for configuration and connection. In case of not finding an IOT HUB 107, the user can perform the DEVICE SEARCH again which can have a limited duration of time.

Once the USER CONTROL INTERFACE 122 successfully connects to the AI/IOT HUB 107, the CONFIGURATION is SENT at block 166 by means of a request to an internal local server of the AI/IOT HUB 107 using HTTP protocol, in a specific structure and embodiment.

This information is stored in the internal memory of the selected AI/IOT HUB 107 at the next step APPLY CONFIGURATION at block 167, during which, the AI/IOT HUB 107 will attempt to connect to the Wi-Fi network indicated through the USER CONTROL INTERFACE 122, with its respective credentials in the WIFI NETWORK SELECTION at block 164.

After APPLYING CONFIGURATION at block 167, a CONNECTION VERIFICATION at block 168 is performed, if for some reason the AI/IOT HUB 107 fails to establish a connection with the Wifi network (e.g., information entered incorrect by the user, network not available, among others). As long as after achieving a good connection, a stable connection with the Internet is then not obtained, the CONNECTION VERIFICATION at block 168 will return a negative result, which will eliminate the data sent by the USER CONTROL INTERFACE 122 and restart the IOT HUB 107 with the configuration process again. If, on the other hand, an Internet connection is achieved, the IOT HUB 107 will execute a SUCCESS RESPONSE at block 169 by sending a successful configuration message or acknowledgement to the USER CONTROL INTERFACE 122 and display a physical signal (visually or audibly) to indicate that the process finished correctly.

The embodiments described have the capability to control various types of appliances or electronic devices. Accordingly, embodiments include one or more antennas arranged to work at specific frequencies, as well as one or several integrated circuits or microcontrollers arranged for the modulation, demodulation, and signal processing for achieving effective communication by means of radiofrequency signals.

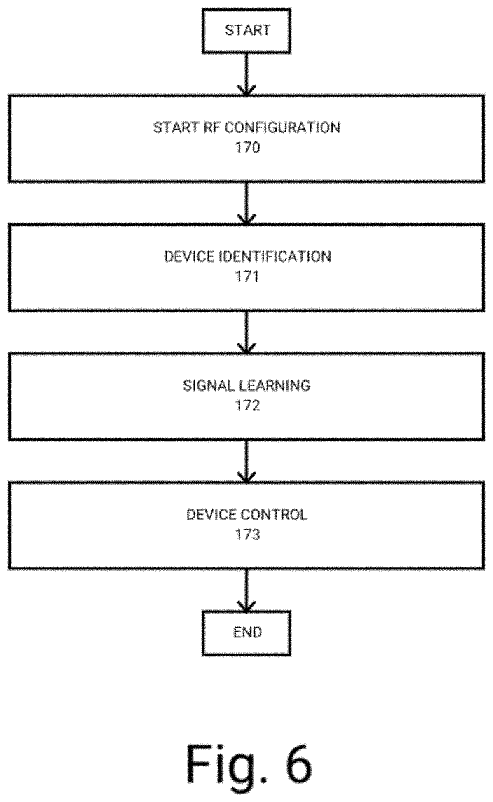

In order to control devices that use this type of communication to be wirelessly controlled by the user, a configuration process must first be carried out as indicated in FIG. 6 so that all the information (such as type of device, brand, model, signal length, signal transfer speed, among other parameters) necessary to control the device(s) through the IOT HUB is established.

Referring to FIG. 6, the user must START THE RF CONFIGURATION at block 170 from the user interface being used (Application installed on the user's device or WebSocket from a browser), which will guide the user through the entire process.

The user must then provide information to achieve the DEVICE IDENTIFICATION at block 171 that the user wants to control (including, but not limited to type, brand, and model, among others), and based on this information a base template with the appropriate buttons will be used according to the user's choice. This information can be stored in a database together with other relevant information that can be used by different artificial intelligence services and data processing to expand the amount of services offered in accordance with the embodiments.

Once the DEVICE IDENTIFICATION at block 171 ends, the system performs SIGNAL LEARNING at block 172, where a sample of the signal sent by the original remote control of the device to be controlled will be taken and processed to extract information such as length, transfer speed, data of the sent signal and such extracted information will be stored in the internal memory to be sent later upon request of the user by sending a command through the user interface. It is important to clarify that the user must perform this process of SIGNAL LEARNING at block 172 as many times as necessary until all the buttons or functionalities required by the type of device are added.

Once the SIGNAL LEARNING process at block 172 has been completed, a template will be available in the user interface, simulating (or substantially simulating) the original control of the device, and through this simulation the user will intuitively send commands to be executed in the AI/IOT HUB and thus CONTROL THE DEVICE at block 173.

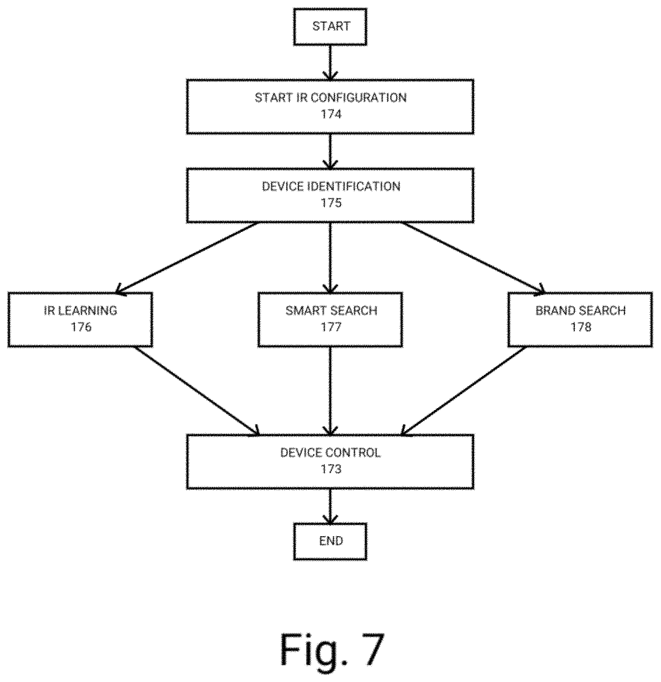

In FIG. 7, different methods that can be applied to achieve an AI/IOT HUB that are able to configure and subsequently control devices controlled by infrared signals.

The first of these implementations requires the use of an infrared receiver, in conjunction with an infrared signal processor to record, process and store the original remote control signal (learning). As in the process of configuring devices controlled by RF signals, the user must START IR CONFIGURATION at block 174 through the user interface, which will initiate a step-by-step guide of the actions to be performed by the user on the platform.

As a first step, the user must perform the DEVICE IDENTIFICATION at block 175, where the user provides information (such as type of device, brand, model, among others) about the device controlled by infrared signals desired for configuration. The platform uses the provided information to facilitate the learning process, select the correct type of remote control template that will be used as a control interface, and to update the database with such information and further allow different artificial intelligence services to process the information in a manner that improves performance of AI/IOT HUB.

Once the information collection is completed during the DEVICE IDENTIFICATION at block 175, the user will be informed what button to press and how the IR LEARNING process should be performed at block 176 to be received by the infrared receiver, analyzed correctly by the infrared signal processor and stored. This process must be done as many times as necessary to complete the control template according to the type of device and brand.

Upon completion, all infrared codes stored during the IR LEARNING process at block 176 will be available for the user to send as a command during DEVICE CONTROL at block 173 through the templates that will be found on the platform.

Another of the implementations shown in FIG. 7 for the configuration of devices controlled by infrared signals in the AI/IOT HUB, is by using the function BRAND SEARCH at block 178. To be able to use this method, the user would essentially follow the same steps used for IR LEARNING at block 176 by using DEVICE IDENTIFICATION at block 175 to facilitate a search of devices by brand. The BRAND SEARCH at block 178 is a much shorter, easier and more intuitive process for the user.

Once all the necessary information has been collected, a BRAND SEARCH at block 178 will be executed, which causes the sending of a request to an API that controls the infrared code database. In response to the request, the infrared code database returns a list of possible infrared codes. Depending on the type of device and brand, this list can increase or decrease its size, and for this reason, this list will start with the most common models and will continue with the infrared codes belonging to models with less use or sales.

Once that list is obtained, the platform presents the user with a temporary template through which the user can test a specific infrared code from the list and check if it is appropriate for its device, where each time the user presses a button of test, the user will be asked if the device to be configured reacted as expected, which will serve as feedback of the process to continue with the next code of the obtained list or to stop at the current one.

Once the user indicates through the platform that the current infrared code obtained through BRAND SEARCH at block 178 works correctly, the system proceeds to download the complete list of codes, and to organize them in the template that will be used for the CONTROL OF DEVICE at block 173.

SMART SEARCH at block 177 is the last method shown in FIG. 7 for the configuration of infrared devices. Of all the methods, this one offers the greatest facility or ease when carrying out the configuration process, however, the other methods are not ruled out in order to provide the user with greater flexibility in how to configure their devices.

As in the previous two methods, the user must START IR CONFIGURATION at block 174 and then make the DEVICE IDENTIFICATION at block 175 to ensure that the SMART SEARCH at block 177 is executed properly and offers quick results for the user.

When starting this procedure, the user will be presented with a single button on the screen and the function of the button will be indicated, which must be executed by the device that is being configured correctly. If not, the user can provide feedback to the algorithm indicating that the expected response was not met. On the other hand, if it was executed correctly and the user indicates it, then it is passed to the next button/function to execute, depending on the type of device, it may be necessary to evaluate 3 or more buttons/functions in order to find the arrangement of infrared codes corresponding to the device that you want to configure.

Although the SMART SEARCH at block 177 and the BRAND SEARCH at block 178 have similarities, the SMART SEARCH at block 177 process substantially reduces the probability of obtaining an infrared code arrangement since not all the buttons are compatible with the device to be configured, unless a pre-check of each button during the BRAND SEARCH at block 178 is done, which also decreases the number of infrared codes to be tested and the time required by the user to configure the same device with respect to the methods IR LEARNING (176) and BRAND SEARCH (178).

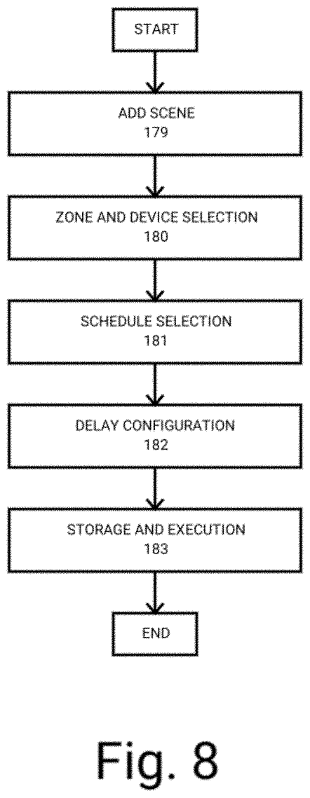

In FIG. 8, an implementation of the embodiments for the control of devices by means of macro commands is shown. That is to say, the execution of successive commands spaced apart from one another for a period of time, for the control of different devices simultaneously, which can be used by the user to set the room in a predetermined way without the need to change templates, to alternate between devices to control or multiple pulsations on the same device.

This level of control can only be used with a previous configuration as shown in FIG. 8 and is only available to the user after having successfully configured one or more zones. This process must be created by the user within the user interface or control platform chosen by selecting the option ADD SCENE at block 179, as in the configuration process of infrared or radio frequency devices, this option will take the user through a step-by-step guide, to more easily achieve a successful configuration.

After starting the process of ADD SCENE at block 179, the user will be shown the zones and devices that have been previously configured for the use of macro commands and will be asked to perform a SELECTION OF ZONE AND DEVICES at block 180 that the user may want to add/use in creation of the scene. These zones and devices were previously configured successfully to ensure that the execution of the scene does not fail.

Once the devices that were used have been selected, the user must perform the SCHEDULE SELECTION (time selection) at block 181, that is, the moment in which the scene will take effect. It should be clarified that this is not limited to a single execution, but instead, the user can choose that the scene is implemented routinely for greater control over the area that is controlled. An example of this would be to set a time of day at which the television, air conditioner and home theater will turn on upon the return from work, and execute this scene only on the days when the user must work, this way the user's house “would wait” for the user's arrival with all the devices adjusted to the user's liking.

Due to the difference between types of devices and even more between brands of devices, some of them may take longer to respond or execute an earlier action, so these will not be available to execute a new command, causing that the total execution of the scene is not carried out. For this reason the next step shown in FIG. 8 is the DELAY CONFIGURATION at block 182. At this step, the user will be able to choose according to their criterion, the ideal time that should be expected between the sending of a command and the next one within a certain range, avoiding also very long or unnecessary delays, that would block the execution or these could cross with other commands sent by the user.

Once the SELECTION OF AREA AND DEVICES at block 180, SCHEDULE SELECTION at block 181 and DELAY CONFIGURATION at block 182 has been made, the scene is scheduled and available to the user in the step STORAGE AND EXECUTION at block 183 to be executed by the user at any time with the push of a button, which can be used to check the status of the scene and its correct operation.

Most of the appliances and electronic devices in the house that have a wireless infrared or radio frequency control system, lack a feedback for the user since these are designed to be operated directly with the user in line of sight.

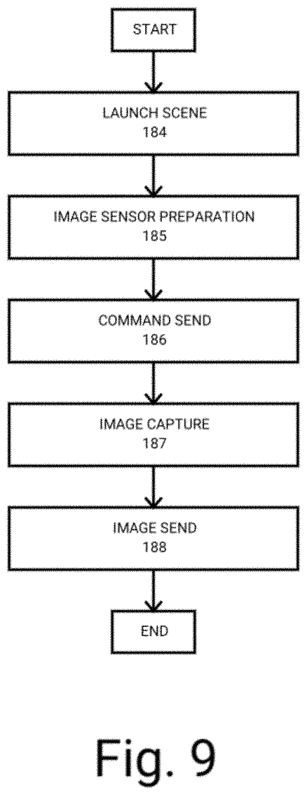

In FIG. 9, the process is shown by which the embodiments are able to provide the user with this feedback through the use of an image sensor in case where a massive control of devices is made remotely. In this way, the user can know if its commands were executed correctly without having to be in situ or in person in the area that is being controlled. Of course, other sensors within contemplation of the embodiments can be used to confirm whether commands were executed correctly, but visual confirmation will likely be the most prevalent.

To carry out this feedback in one particular embodiment, the user must LAUNCH A SCENE at block 184 through the user interface, which will send an initial command, prior to those who will control the devices, for the IMAGE SENSOR PREPARATION at block 185 and resulting image, which will be responsible for providing the feedback. In some embodiments, multiple images can be provided as feedback.

Subsequently, the COMMAND SEND at block 186 starts and executes an order assigned to the scene and waits for the time determined by the user to execute the next one. It should be noted that the times may be different between each scene and between each command sent, as these depend on the number of devices and the type of devices themselves, where those that act physically in the environment (curtains, fans, air conditioner, etc.) take more time to finish executing an action than others. Therefore, the feedback time for the user can vary between scenes.

After the execution of the last delay between control commands, the command is sent to the AI/IOT HUB for IMAGE CAPTURE at block 187 which will make use of an image sensor that in conjunction with a large aperture lens (“fish eye”) can capture most of the space in the area that is located the AI/IOT HUB. The space captured will depend on the location and placement of the HUB. Although a single wide angle or fish eye lens can be used, other embodiments can use a lens that is capable of moving or rotating for additional capture of a scene within a given space. Also note that some embodiments can use multiple lenses as well or other environmental sensors as desired.

The captured image is processed and compressed in order to make better use of the memory and increase the transfer speed for the IMAGE DELIVERY at block 187 to the user interface, where it will be available temporarily as feedback of the state in which it is located of the IOT HUB area, after executing the scene.

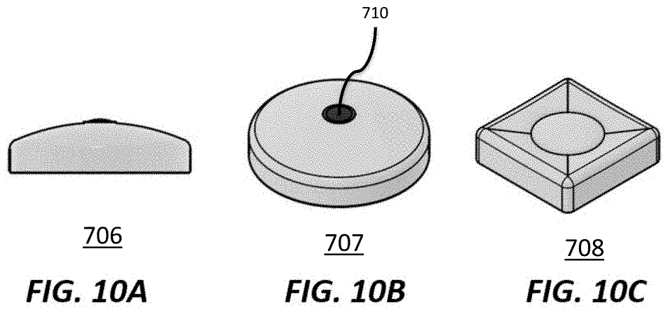

FIGS. 10A, 10B, and 10C illustrate how the embodiments can have several configurations and be developed in many ways without affecting functionality as shown with AI/IOT Hubs 706, 707 and 708 respectively. AI/IOT Hub 707 is shown having a camera or image sensor 710. Additionally, another possible configuration is shown (Hub 708) without the image sensor in FIG. 10C that can be used if this function is not required, without affecting the other functions.

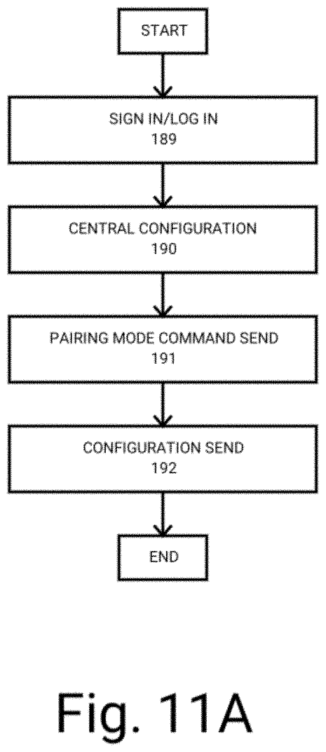

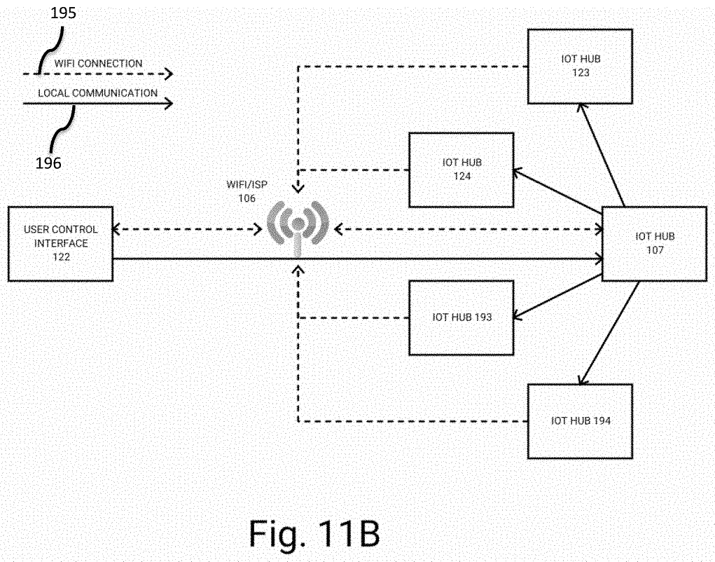

In FIG. 11A-B, an implementation of the embodiments is shown for the configuration of multiple AI/IOT HUBs 123-124-193-194 simultaneously. For this, the process is described in the diagram of FIG. 11A. While FIG. 11B only shows four AI/IOT HUBs 123-124-193-194 being configured by the central AI/IOT HUB 107, the amount may vary without affecting the implementation principles.

The user must make the SESSION START by LOGGING IN at block 189 in the USER CONTROL INTERFACE 122 to be able to initiate the process of CENTRAL CONFIGURATION at block 190 of the AI/IOT HUB 107 which will be the only device that will pass through a manual configuration (standard) and the one in charge of transmitting to the others (as a master) of the AI/IOT HUBs 123-124-193-194 that will be added to the WIFI/ISP 106 network with the configuration and connection credentials with the server.

Once the CENTRAL CONFIGURATION at block 190 has been made in the AI/IOT HUB 107, the command to start PAIRING at block 191 is sent from the USER CONTROL INTERFACE 122, which causes the AI/IOT HUB 107 to disconnect from the WIFI network/ISP 106 losing the INTERNET COMMUNICATION link 196 and start looking for the AI/IOT HUBs 123-124-193-194 that are available to perform the PAIRING at block 191 by establishing a LOCAL COMMUNICATION link 195 with them.

Through this LOCAL COMMUNICATION link 195 the AI/IOT HUB 107 will proceed to carry out the SENDING OF CONFIGURATION at block 192, where the information required by the AI/IOT HUB 123-124-193-194 will be transmitted to establish the INTERNET COMMUNICATION link 196 through one of the WIFI/ISP 106 networks, and similarly, relevant data will be transmitted for the correct operation of the AI/IOT HUBs 123-124-193-194 with the servers and the USER CONTROL INTERFACE 122.

What is claimed is:

1. An Artificial Intelligence/Internet of Things (AI/IOT) HUB with at least one Internet connection interface, for forming an Internet connection and access to various services including IoT services and for controlling a plurality of controlled devices, the AI/IOT HUB comprising:
at least one user interface enabling a user to send commands to the AI/IOT HUB;
at least one environmental sensor including an image sensor for detection and feedback of current conditions within a zone or room for the AI/IOT HUB;
a memory having computer instructions stored therein;
one or more processors coupled to the memory and the at least one environmental sensor, wherein the one or more processors upon execution of the computer instructions cause the one or more processors to perform the operations comprising:
creating a local communication channel among a plurality of other AI/IOT HUBs;
simultaneously configuring the plurality of other AI/IOT HUBs with minimal user intervention;
creating a local communication network in an event of loss of the Internet connection
controlling the controlled devices using infrared (IR), radio frequency (RF), Wifi, or Bluetooth signals;
controlling several of the controlled devices simultaneously for a conditioning of the room or the zone;
detecting current conditions within the zone or the room having the controlled devices using the image sensor after activating the controlled devices; and
providing feedback with output from the image sensor to confirm the conditioning of the room or of the zone; and
an AI interface, with intelligent learning capacity that adapts and learns user preferences, stores such user preferences in a local database and predicts and presents user options using the intelligent learning.

2. The system HUB of claim 1, wherein the HUB further includes a connection to an IR database having an identity of the controlled device.

3. The HUB of claim 1, wherein the controlled devices comprise one or more among air conditioners (ACs), audiovisual equipment, lights, curtains, fans, plugs, temperature control systems, IoT devices and other devices that have an identifiable control signal and compatible with the AI/IOT HUB or accessible through an application programming interface (API).

4. The HUB of claim 1, wherein the one or more processors is further configured to transmit a user control signal over the Internet, local Wi-Fi networks, or Bluetooth BLE, depending on the type of connection provided by the AI/IoT HUB and the user interface.

5. The HUB of claim 1, wherein the HUB further includes an internal circuit connected to the image sensor for taking a photograph of a room within the zone to provide feedback to the user of the current conditions in the room.

6. The HUB of claim 1, wherein the one or more processors is further configured to create the local network to interconnect several AI/IOT Hubs and transmit configuration data.

7. The HUB of claim 1, wherein the one or more processors is further configured to control the plurality of controlled devices simultaneously while in the same area as the AI/IOT Hub.

8. The HUB of claim 7, wherein the one or more processors is further configured to control different controlled devices previously configured regardless of brand, type or control signal used by the different controlled devices.

9. The HUB of claim 7, wherein the one or more processors is further configured to use the image sensor for feedback of the current conditions of the area or zone where the AI/IOT Hub is located.

10. The HUB of claim 1, wherein the one or more processors is further configured to configure the other AI/IOT HUBs that are compatible simultaneously and transfer connection credentials and user profile information.

11. The HUB of claim 10, wherein other AI/IOT HUBs are configured using the local communication channel.

12. The HUB of claim 10, wherein other AI/IOT HUBs are configured using one or more among IR, Bluetooth, RF, or Wifi.

13. The HUB of claim 1, wherein the one or more processors is further configured to control the plurality of controlled devices from different user interfaces and for a plurality of users.

14. The HUB of claim 1, further comprising a user account management system that differentiates between administrator and guests.

15. The HUB of claim 1, wherein the image sensor uses a wide angle lens or fish eye lens.

16. A computerized method, the method comprising:
receiving via a user interface commands to an artificial intelligence/Internet of Things (AI/IOT) HUB coupled to an Internet connection or a local connection;
creating via the HUB a local communication channel among a plurality of other AI/IOT HUBS using the local connection;
simultaneously configuring via the HUB the plurality of other AI/IOT HUBs with minimal user intervention;
creating via the HUB a local communication network in an event of loss of the Internet connection controlling via the HUB, a plurality of controlled devices using infrared (IR), radio frequency (RF), Wifi, or Bluetooth signals;
controlling via the HUB several of the controlled devices simultaneously for a conditioning of a room or a zone;
detecting via an image sensor in the HUB, current conditions within a zone having the controlled devices after activating the controlled devices; and
providing feedback via the user interface coupled to the HUB with output from the image sensor to confirm the conditioning of the room or of the zone.

17. The method of claim 16, wherein the user interface is an AI interface, with intelligent learning capacity that adapts and learns user preferences, stores such user preferences in a local database and predicts and presents user options with the intelligent learning.

18. The method of claim 16, wherein the HUB controls one or more controlled devices selected among air conditioners (ACs), audiovisual equipment, lights, curtains, fans, plugs, temperature control systems, IoT devices and other devices that have an identifiable control signal and compatible with the AI/IOT HUB or accessible through an application programming interface (API).

19. An Artificial Intelligence/Internet of Things (AI/IOT) HUB with at least one Internet connection interface, for forming an Internet connection and access to various services including IoT services and for controlling a plurality of controlled devices, the AI/IOT HUB comprising:
at least one user interface enabling a user to send commands to the AI/IOT HUB, wherein the at least one user interface includes an AI interface with intelligent learning capacity that adapts and learns user preferences, stores such user preferences in a local database and predicts and presents user options using the intelligent learning;
a memory having computer instructions stored therein;
one or more processors coupled to the memory and the at least one environmental sensor, wherein the one or more processors upon execution of the computer instructions cause the one or more processors to perform the operations comprising:
creating a local communication channel among a plurality of other AI/IOT HUBs;
simultaneously configuring the plurality of other AI/IOT HUBs with minimal user intervention;
creating a local communication network in an event of loss of the Internet connection;
controlling the controlled devices using infrared (IR), radio frequency (RF), Wifi, or Bluetooth signals; and
controlling several of the controlled devices simultaneously for a conditioning of the room or the zone.

20. The HUB of claim 19, wherein the one or more processors are further configured to perform the operations comprising:
detecting current conditions within the zone or the room having the controlled devices using an image sensor coupled to the HUB after activating the controlled devices; and
providing feedback with output from the image sensor providing visual confirmation of the conditioning of the room or of the zone.
